(19) United States
(12) Patent Application Publication
(10) Pub. No.: US 2007/0015655 A1
(43) Pub. Date: Jan. 18, 2007

(54) Hollow piece for producing a sintered refractory product exhibiting improved bubbling behaviour

(75) Inventors: Richard Avedikian, Robion (FR); Yves Bous Sant-Roux, Montfavet (FR); Jacques Guigonis, Pernes Les Fontaines (FR)

Correspondence Address: YOUNG & THOMPSON, 745 SOUTH 23RD STREET, 2ND FLOOR, ARLINGTON, VA, 22202, US

(73) Assignee: SAINT-GOBAIN CENTRE DE RECHERCHES ET D'ETUDES EUROPEEN, COURBEVOIE (FR)

(21) Appl. No.: 10/569,955

(22) PCT Filed: Aug. 30, 2004
(86) PCT No.: PCT/FR04/02210

§ 371 Date: Feb. 28, 2006

(30) Foreign Application Priority Data
Sep. 1, 2003 (FR) 0310350

(51) Int. Cl. C04B 35/18; C04B 35/106

(52) U.S. Cl. 501/128; 501/107

(57) ABSTRACT

The invention relates to a hollow piece for producing a sintered refractory having the following mean mineral chemical composition in weight percent based of mineral oxides: 40%=Al₂O₃=94%, 0%=ZrO₂=41%, 2%=SiO₂=22%, 1%<Y₂O₃+V₂O₅+TiO₂+Sb₂O₃+Yb₂O₃+Na2O.

The invention relates to an aluminous sintered refractory product, to a process for manufacturing this refractory product and to a green part, or “preform”, intended to be sintered in order to obtain this refractory product.

Among refractories, a distinction may be made between fused-cast products and sintered products.

Unlike sintered products, as described for example in US 2001/0019992 A1, fused-cast products usually comprise an intergranular glassy phase that links the crystallized grains together. The problems posed by sintered products and by fused-cast products, and the technical solutions adopted for solving them, are therefore generally different. A composition developed for manufacturing a fused-cast product cannot therefore a priori be used as such for manufacturing a sintered product, and vice versa.

Sintered products are obtained by mixing appropriate raw materials, then making a green form from this mixture and firing the resulting green form at a temperature and for a time that are sufficient to sinter this green form. This firing may be carried out in firing furnaces or else in situ in the glass furnace for products sold unfired or unfashioned.

Sintered products, depending on their chemical composition and their method of preparation, are intended for a wide variety of industries.

Among sintered products, alumina-zirconia-silica products, commonly called AZS products, and also called aluminous products are used in zones of glass-melting furnaces.

Products such as those described in FR 2 552 756 in the name of Emhart Industries are generally very suitable. Products such as BPAL, ZA33 or ZIRAL, which are produced and sold by Saint-Gobain SefPro, are also particularly well suited and very widely used at the present time. However, with certain recent glass compositions, the formation of bubbles has been observed. These bubbles are generated upon contact with the refractories that make up the furnace and are then trapped in the glass, giving rise to unacceptable defects.

There is therefore a need for a sintered product that gives rise to reduced bubbling effect and that can be used in glass furnaces. The aim of the present invention is to satisfy this need.

For this purpose, the invention proposes a green part having the following average mineral chemical composition, in percentages by weight on the basis of the mineral oxides:
40%≦Al₂O₃≦94%,
0%≦ZrO₂≦41%,
2%≦SiO₂≦22%, preferably 3%≦SiO₂≦22%
1%<Y₂O₃+V₂O₅+TiO₂+Sb₂O₃+Yb₂O₃+Na₂O.

Advantageously, as we will see later, the sintered refractory products obtained from this green part give rise to a reduced bubbling effect.

According to other preferred features of the invention:
TiO₂≧2%;
ZrO₂<35%, preferably ZrO₂<30%;
the total Y₂O₃+V₂O₅+TiO₂+Sb₂O₃+Yb₂O₃+Na₂O content is 5% or less. This is because, above this value, the main crystalline phases may be modified, resulting in degradation of other properties of the products (corrosion resistance or release of defects for example);
the total Y₂O₃+V₂O₅+TiO₂+Sb₂O₃+Yb₂O₃+Na₂O content is greater than 1%, preferably greater than 2% and more preferably greater than 3%, in percentages by weight on the basis of the mineral oxides. This is because a high Y₂O₃+V₂O₅+TiO₂+Sb₂O₃+Yb₂O₃+Na₂O content advantageously improves the bubbling behavior of the product; and
the content of at least one oxide from Y₂O₃, V₂O₅, TiO₂, Sb₂O₃, Yb₂O₃ and Na₂O, preferably from Y₂O₃, V₂O₅, TiO₂, Sb₂O₃ and Yb₂O₃ and even more preferably from Y₂O₃ and TiO₂ is greater than 1%, preferably greater than 2% and more preferably greater than 3%, in percentages by weight on the basis of the mineral oxides. TiO₂ and Y₂O₃ are the preferred oxides from Y₂O₃, V₂O₅, TiO₂, Sb₂O₃, Yb₂O₃ and Na₂O. This is because they give very good results at a reduced cost. However, the use of Na₂O may be prejudicial to feasibility on an industrial scale since the possible formation of nepheline (2SiO₂Al₂O₃Na₂O) may lead to defects.

The invention also relates to a refractory product that is obtained by sintering a green part according to the invention that therefore has an average mineral chemical composition in terms of oxides in accordance with that of a green part according to the invention.

This is because the oxide composition of the sintered product is approximately equal to that of the green part and of the starting mixture.

The invention also relates to the use of a refractory product according to the invention in a region of a glassmaking furnace, in particular for the manufacture of soda-lime (CSL) or extra-white soda-lime (EWSL) glass.

Finally, the invention relates to a process for manufacturing a sintered refractory product, comprising at least the following successive steps:

a) preparation of a green part according to the invention from a mixture of raw materials to which has been added an amount of greater than 1% of a constituent consisting of one or more of the oxides from Y₂O₃, V₂O₅, TiO₂, Sb₂O₃, Yb₂O₃ and Na₂O, in percentages by weight on the basis of the mineral oxides; and

b) sintering of said green part.

Advantageously, adding an amount greater than 1% of a constituent comprising at least one oxide from Y₂O₃, V₂O₅, TiO₂, Sb₂O₃, Yb₂O₃ and Na₂O ensures that this amount exceeds 1% in the manufactured product, whatever the level of impurities of the raw materials used.

The term “green part” is understood to mean the part before sintering. The sintering corresponds to the thermal consolidation of the material. It is generally accompanied by a reduction in the porosity and by dimensional shrinkage. Conventionally, the green part consists of mineral oxides (mineral chemical composition), water and organic compounds (binders) that provide the part with mechanical integrity. The water and the organic binders are removed during the sintering thermal cycle.

The following nonlimiting examples are given for the purpose of illustrating the invention.

In these examples, the raw materials employed were chosen from:
particles having a size of between 0 and 20 mm, which are obtained by milling electrocast refractories such as ER-1681 or ER-1711, produced and sold by Société Européenne des Produits Réfractaires [European Refractories Society]. These products contain, in percentage by weight on the basis of the oxides: 32 to 54% ZrO₂; 36 to 51% Al₂O₃; 2 to 16% SiO₂; and 0.2 to 1.5% Na₂O;
tabular or electrocast alumina particles containing more than 99% alumina having a size of between 40 μm and 3.5 mm;
fused or sintered mullite particles, for example a powder containing 76.5% Al₂O₃ and 22.5% SiO₂, the particle size varying from 0.7 to 3 mm;
products having a high zirconia content, such as CS10 or CC10, sold by Société Européenne des Produits Réfractaires. These products contain more than 99% ZrO₂ and the mean diameter (D₅₀) of the zirconia particles is 3.5 μm;
reactive alumina, or a mixture of reactive aluminas, containing more than 99% Al₂O₃, it being possible for the mean diameter of the reactive alumina particles to vary from 0.5 μm to 3 μm;
electrocast alumina, the particles of which have a size of between 0.04 and 0.5 mm;
silica fume sold by Société Européenne des Produits Réfractaires. This vitreous silica contains more than 93% silica (SiO₂) and takes the form of a powder whose particles have a mean diameter of at most 1 μm. All our examples contain at least 2% thereof;
a hydraulic cement or a mixture of various cements; it is preferred to use a high-alumina cement, such as CA25 from Alcoa. CA25 contains more than 78% Al₂O₃ and less than 19% CaO;
zircon in sand or well-micronized form, containing 33% silica;
yttrium oxide, titanium oxide, vanadium oxide, ytterbium oxide and/or antimony oxide of greater than 99% purity; and
calcium carbonate Na₂CO₃.

Sintered refractory blocks were manufactured according to a process conventionally comprising the following steps:

a) preparation of a mixture of raw materials;

b) formation of a green part from said mixture; and

c) sintering of said green part.

At step a), the raw materials were metered so that the mixture had the desired average mineral chemical composition by weight, and then mixed in the presence of water and at least one dispersant, for example a sodium phosphate.

The mixture was then cast in a mould with the dimensions 230 mm×114 mm×64 mm so as to form a green part having sufficient mechanical strength to be able to be handled.

The green part was then sintered at a temperature of between 1300° C. and 1500° C., so as to form a refractory block.

Specimens were taken from the various examples of blocks produced in order to carry out bubbling tests. The specimen of refractory constituted a crucible having a wall thickness of 5 mm and an inside diameter of 30 mm.

In this test, the specimen contained glass. The type of glass is indicated in Table 1. This is conventional soda-lime (CSL) glass or extra-white soda-lime (EWSL) glass.

The crucible containing the glass was then brought to the desired temperature (1250° C. in the case of CSL and 1150-1250° C. in the case of EWSL glass) in air for 30 hours in order to reproduce the temperature and atmosphere conditions characteristic of industrial operating conditions.

The bubble index (BI) was then measured, this being between 1 (minimum bubbling) and 10 (intense bubbling), corresponding to the number of gas bubbles trapped in the glass after cooling. The bubble index is considered as good if it is equal to 5 or below.

The chemical composition of various products tested and the results of the tests are given in Table 1. The composition is an average chemical composition, given as a percentage by weight on the basis of the mineral oxides. The balance corresponds to CaO and to impurities such as MgO, K₂O and Fe₂O₃.

TABLE 1

| Test | Al₂O₃ (%) | ZrO₂ (%) | SiO₂ (%) | Addition | Addition (%) | Glass | BI |
|---|---|---|---|---|---|---|---|
| 1 | 75.5 | 10.5 | 12.5 | | 0 | EWSL | 9 |
| 2 | 75.0 | 10.5 | 12.5 | Y₂O₃ | 0.5 | EWSL | 9 |
| 3 | 74.5 | 10.5 | 12.5 | Y₂O₃ | 1 | EWSL | 5 |
| 4 | 74.0 | 10.5 | 12.5 | Y₂O₃ | 1.5 | EWSL | 4 |
| 5 | 73.5 | 10.5 | 12.5 | Y₂O₃ | 2 | EWSL | 2 |
| 6 | 72.5 | 10.5 | 12.5 | Y₂O₃ | 3 | EWSL | 2 |
| 7 | 71.5 | 10.5 | 12.5 | Y₂O₃ | 4 | EWSL | 2 |
| 8 | 70.5 | 10.5 | 12.5 | Y₂O₃ | 5 | EWSL | 2 |
| 9 | 70.0 | 19.0 | 10.0 | | 0 | EWSL | 9 |
| 10 | 68.0 | 19.0 | 10.0 | Y₂O₃ | 2 | EWSL | 5 |
| 11 | 67.0 | 19.0 | 10.0 | Y₂O₃ | 3 | EWSL | 5 |
| 12 | 53.0 | 28.5 | 16.0 | | 0 | EWSL | 6 |
| 13 | 51.0 | 28.5 | 16.0 | Y₂O₃ | 2 | EWSL | 5 |
| 14 | 93.0 | 0.0 | 6.0 | | 0 | EWSL | 8 |
| 15 | 91.5 | 0.0 | 6.0 | Y₂O₃ | 1.5 | EWSL | 5 |
| 16 | 91.0 | 0.0 | 6.0 | Y₂O₃ | 2 | EWSL | 5 |
| 17 | 91.0 | 0.0 | 6.0 | Y₂O₃ | 2 | EWSL | 5 |
| 18 | 90.0 | 0.0 | 6.0 | Y₂O₃ | 3 | EWSL | 5 |
| 19 | 89.0 | 0.0 | 6.0 | Y₂O₃ | 4 | EWSL | 5 |
| 20 | 93.0 | 0.0 | 6.0 | | 0 | CSL | 6 |
| 21 | 92.0 | 0.0 | 6.0 | Y₂O₃ | 1 | CSL | 5 |
| 22 | 91.0 | 0.0 | 6.0 | Y₂O₃ | 2 | CSL | 5 |
| 23 | 90.0 | 0.0 | 6.0 | Y₂O₃ | 3 | CSL | 4 |
| 24 | 89.0 | 0.0 | 6.0 | Y₂O₃ | 4 | CSL | 4 |
| 25 | 48.0 | 30.0 | 20.0 | | 0 | EWSL | 7 |
| 26 | 46.0 | 30.0 | 20.0 | Y₂O₃ | 2 | EWSL | 3 |
| 27 | 45.0 | 30.0 | 20.0 | Y₂O₃ | 3 | EWSL | 3 |
| 28 | 45.0 | 28.0 | 22.0 | Y₂O₃ | 3 | EWSL | 3 |
| 29 | 42.0 | 33.0 | 20.0 | Y₂O₃ | 3 | EWSL | 3 |
| 30 | 91.5 | 0.0 | 6.0 | TiO₂ | 1.5 | EWSL | 7 |
| 31 | 91.0 | 0.0 | 6.0 | TiO₂ | 2 | EWSL | 5 |
| 32 | 90.0 | 0.0 | 6.0 | TiO₂ | 3 | EWSL | 3 |
| 33 | 88.5 | 0.0 | 6.0 | TiO₂ | 4.5 | EWSL | 3 |
| 34 | 40.0 | 32.0 | 22.0 | TiO₂ | 4.0 | EWSL | 4 |
| 35 | 92.0 | 0.0 | 6.0 | Sb₂O₃ | 1.0 | EWSL | 5 |
| 36 | 90.0 | 0.0 | 6.0 | Sb₂O₃ | 3 | EWSL | 2 |
| 37 | 89.0 | 0.0 | 6.0 | Sb₂O₃ | 4.0 | EWSL | 2 |
| 38 | 91.5 | 0.0 | 6.0 | V₂O₃ | 1.5 | EWSL | 4 |
| 39 | 90.5 | 0.0 | 6.0 | V₂O₃ | 2.5 | EWSL | 4 |
| 40 | 91.0 | 0.0 | 6.0 | Yb₂O₃ | 1.0 | EWSL | 4 |
| 41 | 90.0 | 0.0 | 6.0 | Yb₂O₃ | 2.0 | EWSL | 3 |
| 42 | 92.0 | 0.0 | 6.0 | Na₂O | 1.0 | EWSL | 5 |
| 43 | 90.5 | 0.0 | 6.0 | Na₂O | 2.5 | EWSL | 5 |
| 44 | 93.0 | 0.0 | 4.0 | Y₂O₃ | 2.0 | CSL | 4 |
| 45 | 94.0 | 0.0 | 4.0 | Y₂O₃ | 1 | CSL | 5 |
| 46 | 90.0 | 0.0 | 5.0 | TiO₂ | 4.0 | EWSL | 3 |
| 47 | 71.5 | 10.5 | 12.5 | Y₂O₃(2) + TiO₂(2) | 4.0 | EWSL | 2 |
| 48 | 70.5 | 10.5 | 12.5 | Y₂O₃(3) + Sb₂O₃(2) | 5.0 | EWSL | 2 |
| 49 | 98.5 | 0.0 | 5.0 | Y₂O₃(2.5) + Yb₂O₃(2) | 4.5 | EWSL | 3 |
| 50 | 40 | 40 | 15 | Y₂O₃ | 3 | EWSL | 3 |
| 51 | 42 | 37 | 16 | Y₂O₃ | 3 | EWSL | 4 |
| 52 | 95 | 0 | 3 | Y₂O₃ | 2 | CSL | 5 |
| 53 | 96.7 | 0 | 2.3 | Y₂O₃ | 0 | EWSL | 6 |
| 54 | 95.7 | 0 | 2.3 | Y₂O₃ | 1 | EWSL | 3 |
| 55 | 94.7 | 0 | 2.3 | Y₂O₃ | 2 | EWSL | 2 |
| 56 | 96.7 | 0 | 2.7 | Y₂O₃ | 0 | EWSL | 6 |
| 57 | 95.7 | 0 | 2.7 | Y₂O₃ | 1 | EWSL | 4 |
| 58 | 94.7 | 0 | 2.7 | Y₂O₃ | 2 | EWSL | 2 |

These examples show that a total addition of one or more of the oxides Y₂O₃, V₂O₅, TiO₂, Sb₂O₃, Yb₂O₃ and Na₂O of above 1% preferably above 1.5% reduces bubbling and thus considerably reduces the formation of defects in the glass.

It is difficult to introduce Sb₂O₃ because it partially volatilizes during sintering. Yb₂O₃ is a very expensive compound compared with the other oxides of the composition. Moreover, TiO₂ has, in certain cases, a risk of coloring the glass and could act on the sintering. For these reasons, Y₂O₃ is the preferred addition for reducing bubbling. The examples show that it has an optimum effect for a content of between 1.5 and 2.5%.

Comparing Examples 14 and 30 shows that the addition of 1.5% TiO₂ has a positive effect on the bubble index. However, comparison of Examples 30 and 31 shows that a TiO₂ content of greater than 2% is preferable when TiO₂ constitutes the only oxide from Y₂O₃, V₂O₅, TiO₂, Sb₂O₃, Yb₂O₃ and Na₂O that had to be added.

Crystallographic analysis of the products of the invention shows that the main phase is corundum, possibly combined with mullite and zirconia.

Moreover, when zirconia is present it is in monoclinic or tetragonal form. The Y₂O₃+V₂O₅+TiO₂+Sb₂O₃+Yb₂O₃+Na₂O contents of the invention are therefore insufficient to completely stabilize the zirconia. Moreover, it is found that these oxides make it possible to reduce bubbling on aluminous products containing no zirconia. The invention therefore does not pertain to zirconia stabilization.

Without being tied down by any theory, the Applicant explains the performance of the products according to the invention in the following manner.

Mullite in the fine fraction could result in a modification of the conduction properties of the product, in particular of its fines (particles smaller than 50 μm), by the creation of new phases or by limitation of existing phases in the control product (for example mullite). The presence in the green part of one or more of the oxides from Y₂O₃, V₂O₅, TiO₂, Sb₂O₃, Yb₂O₃ and Na₂O would advantageously limit the availability of alumina and/or silica which are liable to react to form mullite in the fine fraction.

Of course, the present invention is not limited to the embodiment described and shown, being provided by way of nonlimiting illustrative example.

1-15. (canceled)

16. Green part having the following average mineral chemical composition, in percentages by weight on the basis of the mineral oxides:
40%≦AI₂O₃,
0%≦ZrO₂≦41%,
2%≦SiO₂≦22%,
1%<Y₂O₃+V₂O₅+TiO₂+Sb₂O₃+Yb₂O₃+Na₂O, said green part being obtained by adding to a mixture of raw materials an amount greater than 1% of a constituent consisting of one or more of the oxides from Y₂O₃, V₂O₅, TiO₂, Sb₂O₃, Yb₂O₃, and Na₂O.

17. Green part according to claim 16, having the following average mineral chemical composition, in percentages by weight on the basis of the mineral oxides:
40%≦AI₂O₃≦94%,
0%≦ZrO₂≦41%,
2%≦SiO₂≦22%,
1%<Y₂O₃+V₂O₅+TiO₂+Sb₂O₃+Yb₂O₃+Na₂O.

18. Green part according to claim 16, wherein, in percentages by weight on the basis of the mineral oxides:
3%≦SiO₂.

19. Green part according to claim 16, wherein, in percentages by weight on the basis of the mineral oxides:
TiO₂≧2%.

20. Green part according to claim 16, wherein, in percentages by weight on the basis of the mineral oxides:
Y₂O₃+V₂O₅+TiO₂+Sb₂O₃+Yb₂O₃+Na₂O≦5%.

21. Green part according to claim 16, wherein, in percentages by weight on the basis of the mineral oxides:
Y₂O₃+V₂O₅+TiO₂+Sb₂O₃+Yb₂O₃+Na₂O>2%.

22. Green part according to claim 16, wherein, in percentages by weight on the basis of the mineral oxides:
Y₂O₃+V₂O₅+TiO₂+Sb₂O₃+Yb₂O₃+Na₂O>3%.

23. Green part according to claim 16, wherein the content, in percentages by weight on the basis of the mineral oxides, of at least one oxide from Y₂O₃, V₂O₅, TiO₂, Sb₂O₃, Yb₂O₃ and Na₂O is greater than 1%.

24. Green part according to claim 16, wherein the content, in percentages by weight on the basis of the mineral oxides, of at least one oxide from Y₂O₃, V₂O₅, TiO₂, Sb₂O₃, Yb₂O₃ and Na₂O is greater than 2%.

25. Green part according to claim 16, wherein the content, in percentages by weight on the basis of the mineral oxides, of at least one oxide from Y₂O₃, V₂O₅, TiO₂, Sb₂O₃, Yb₂O₃ and Na₂O is greater than 3%.

26. Green part according to claim 16, wherein, in percentages by weight on the basis of the mineral oxides:
Y₂O₃≧1%.

27. Green part according to claim 16, wherein, in percentages by weight on the basis of the mineral oxides:
Y₂O₃≧2%.

28. Green part according to claim 16, wherein, in percentages by weight on the basis of the mineral oxides:
Y₂O₃≧3%.

29. Process for manufacturing a sintered refractory product, comprising at least the following successive steps:
a) preparation of a green part according to claim 16 from a mixture of raw materials to which has been added an amount of greater than 1% of a constituent consisting of one or more of the oxides from Y₂O₃, V₂O₅, TiO₂, Sb₂O₃, Yb₂O₃ and Na₂O, in percentages by weight on the basis of the mineral oxides; and
b) sintering of said green part.
